(19) United States
(12) Patent Application Publication
(10) Pub. No.: US 2023/0356744 A1
(43) Pub. Date: Nov. 9, 2023

(54) SYSTEM AND METHOD FOR FLEET SCENE INQUIRIES

(71) Applicant: TuSimple, Inc., San Diego, CA (US)

(72) Inventor: Mohammad Poorsartep, Los Gatos, CA (US)

(21) Appl. No.: 18/189,000

(22) Filed: Mar. 23, 2023

Related U.S. Application Data
(60) Provisional application No. 63/364,238, filed on May 5, 2022.

(51) Int. Cl. B60W 60/00; G06V 20/56; G06N 20/00

(52) U.S. Cl. CPC B60W 60/001; G06V 20/56; G06N 20/00; B60W 2556/45

(57) ABSTRACT

Systems and methods for fleet scene inquiries are disclosed herein. In one aspect, an autonomous vehicle includes at least one sensor configured to output sensor data, a memory, and a network communications subsystem configured to receive a scene capture inquiry from an oversight system. The autonomous vehicle further includes a processor configured to: compare the sensor data to the scene capture inquiry based at least in part on a deep learning model, and in response to the sensor data at least generally matching the scene capture inquiry, store the sensor data in the memory as scene data. The deep learning model is trained based on the scene data.

### CROSS-REFERENCE TO RELATED APPLICATION(S)

This application claims the benefit of U.S. Provisional Application No. 63/364,238, filed May 5, 2022, which is hereby incorporated by reference in its entirety. Any and all applications for which a foreign or domestic priority claim is identified in the Application Data Sheet as filed with the present application are hereby incorporated by reference under 37 CFR 1.57.

### BACKGROUND

### Field

The present disclosure relates generally to autonomous vehicles. More particularly, the present disclosure is related to systems and methods for obtaining fleet scene inquiries using an autonomous vehicle (AV) operating appropriately on public roads, highways, and locations with other vehicles or pedestrians.

### Description of the Related Art

One aim of autonomous vehicle technologies is to provide vehicles that can safely navigate towards a destination with limited or no driver assistance. The safe navigation of an autonomous vehicle (AV) from one point to another may include the ability to signal other vehicles, navigating around other vehicles in shoulders or emergency lanes, changing lanes, biasing appropriately in a lane, and navigating all portions or types of highway lanes. Autonomous vehicle technologies may enable an AV to operate without requiring extensive learning or training by surrounding drivers, by ensuring that the AV can operate safely, in a way that is evident, logical, or familiar to surrounding drivers and pedestrians.

### SUMMARY OF CERTAIN INVENTIVE ASPECTS

In one aspect, there is provided an autonomous vehicle, comprising: at least one sensor configured to output sensor data; a memory; a network communications subsystem configured to receive a scene capture inquiry from an oversight system; and a processor configured to: compare the sensor data to the scene capture inquiry based at least in part on a deep learning model, and in response to the sensor data at least generally matching the scene capture inquiry, store the sensor data in the memory as scene data, wherein the deep learning model is trained based on the scene data.

In some embodiments, the scene capture inquiry comprises one or more parametric values that define one or more types of the sensor data to be stored as scene data.

In some embodiments, the one or more parametric values comprises one or more of the following: a time of day parameter, a geofencing parameter, a road condition parameter, and a weather parameter.

In some embodiments, the processor is further configured to compare the sensor data to the one or more parametric values on a frame-by-frame basis.

In some embodiments, the scene capture inquiry is generated by the oversight system based on an input that indicates that the deep learning model has low confidence for a scene defined by the scene capture inquiry.

In some embodiments, the deep learning model is used as part of a perception algorithm running on the autonomous vehicle, the perception algorithm configured to detect objects within the sensor data.

In some embodiments, the autonomous vehicle further comprises: a vehicle drive subsystem configured to drive the autonomous vehicle based at least in part on the sensor data.

In some embodiments, the processor is further configured to in response to the scene data meeting an offloading condition, transmit the scene data to an offboard data storage, and the offloading condition comprises a threshold amount of scene data stored on the memory.

In some embodiments, the processor is further configured to in response to the scene data meeting an offloading condition, transmit the scene data to an offboard data storage, and the offloading condition comprises a threshold amount of time elapsed since the network communications subsystem received the scene capture inquiry.

In some embodiments, wherein the offboard data storage is a cloud server.

In another aspect, there is provided a method performed by a processor of an autonomous vehicle, comprising: receiving sensor data output from a plurality of sensors of the autonomous vehicle; receiving a scene capture inquiry from an oversight system via a network communications subsystem of the autonomous vehicle; comparing the sensor data to the scene capture inquiry based at least in part on a deep learning model; and in response to the sensor data at least generally matching the scene capture inquiry, storing the sensor data in a memory of the autonomous vehicle as scene data, wherein the deep learning model is trained based on the scene data.

In some embodiments, the scene data comprises a collection of data received from two or more of the sensors substantially simultaneously.

In some embodiments, the method further comprises: receiving a perception algorithm comprising the trained deep learning model; and running the perception algorithm at the autonomous vehicle.

In some embodiments, the method further comprises: driving the autonomous vehicle based at least in part on the sensor data and the perception algorithm.

In some embodiments, the perception algorithm is configured to detect objects within the sensor data.

In yet another aspect, there is provided a system for training a deep learning model, comprising: an oversight system configured to generate a scene capture inquiry; an offboard data storage; and a plurality of autonomous vehicles, each of the autonomous vehicles comprising: a vehicle sensor subsystem comprising a plurality of sensors configured to output sensor data, a memory, a network communications subsystem configured to receive the scene capture inquiry from the oversight system, and a processor configured to: compare the sensor data to the scene capture inquiry based at least in part on a deep learning model, and in response to the sensor data at least generally matching the scene capture inquiry, store the sensor data in the memory as scene data, wherein the deep learning model is trained based on the scene data.

In some embodiments, the oversight system is configured to receive an input from a user identifying a type of scene to be obtained by the autonomous vehicles, wherein the generation of the scene capture inquiry is based on the input received from the user.

In some embodiments, the processor of each of the autonomous vehicles is further configured to: run a perception algorithm configured to identify objects in the sensor data for the corresponding autonomous vehicle; and generate a confidence value indicative of a confidence that objects detected by the perception algorithm are accurate based on one or more parameters defining environmental conditions when the sensor data was obtained.

In some embodiments, the oversight system is configured to receive an input from one or more of the autonomous vehicles that indicates that the perception algorithm has a low confidence for the corresponding environmental conditions.

In some embodiments, the oversight system is further configured to receive input from a user indicative of whether the scene data stored in the offboard data storage correctly matches the scene capture inquiry prior to using the scene data for training the deep learning model.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a schematic diagram of a system including an autonomous vehicle.

FIG. 2 shows a flow diagram for operation of an autonomous vehicle (AV) safely in light of the health and surroundings of the AV.

FIG. 3 illustrates a system that includes one or more autonomous vehicles, a control center or oversight system with a human operator (e.g., a remote center operator (RCO)), and an interface for third-party interaction.

FIG. 4 illustrates another example system that can be used to collect scene or event data in accordance with aspects of this disclosure.

FIG. 5 illustrates an example flowchart for a method of collecting scene data used for training a deep learning model in accordance with aspects of this disclosure.

### DETAILED DESCRIPTION

Vehicles traversing highways and roadways are legally required to comply with regulations and statutes in the course of safe operation of the vehicle. For autonomous vehicles (AVs), particularly autonomous tractor trailers, the ability to recognize a malfunction in its systems and stop safely are necessary for lawful and safe operation of the vehicle. Described below in detail are systems and methods for the safe and lawful operation of an autonomous vehicle on a roadway, including the execution of maneuvers that bring the autonomous vehicle in compliance with the law while signaling surrounding vehicles of its condition.

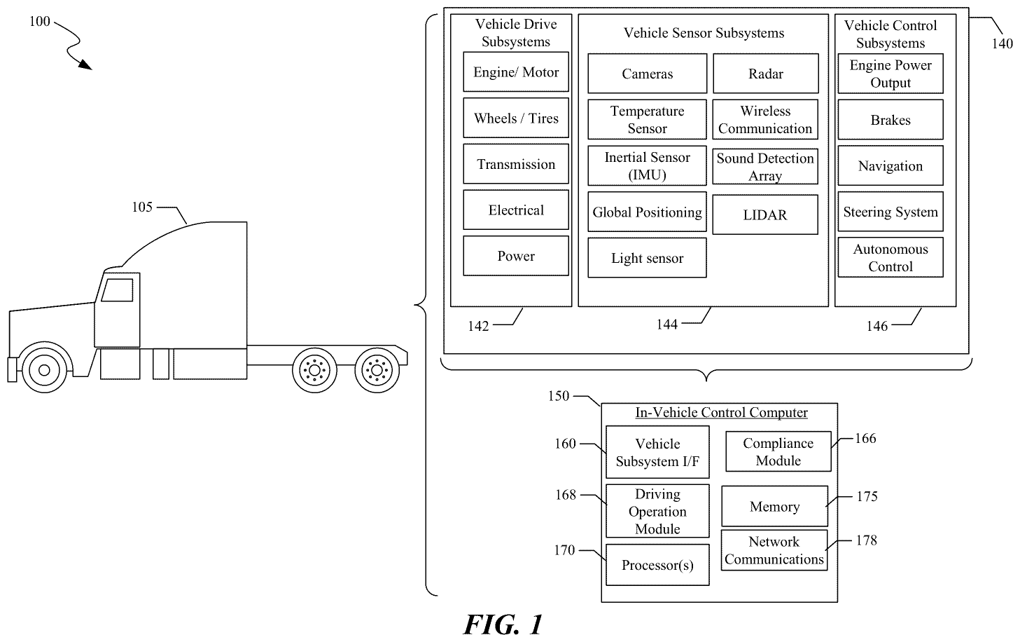

FIG. 1 shows a system 100 that includes a tractor 105 of an autonomous truck. The tractor 105 includes a plurality of vehicle subsystems 140 and an in-vehicle control computer 150. The plurality of vehicle subsystems 140 includes vehicle drive subsystems 142, vehicle sensor subsystems 144, and vehicle control subsystems. An engine or motor, wheels and tires, a transmission, an electrical subsystem, and a power subsystem may be included in the vehicle drive subsystems. The engine of the autonomous truck may be an internal combustion engine, a fuel-cell powered electric engine, a battery powered electrical engine, a hybrid engine, or any other type of engine capable of moving the wheels on which the tractor 105 moves. The tractor 105 have multiple motors or actuators to drive the wheels of the vehicle, such that the vehicle drive subsystems 142 include two or more electrically driven motors. The transmission may include a continuous variable transmission or a set number of gears that translate the power created by the engine into a force that drives the wheels of the vehicle. The vehicle drive subsystems may include an electrical system that monitors and controls the distribution of electrical current to components within the system, including pumps, fans, and actuators. The power subsystem of the vehicle drive subsystem may include components that regulate the power source of the vehicle.

Vehicle sensor subsystems 144 can include sensors for general operation of the autonomous truck 105, including those which would indicate a malfunction in the AV or another cause for an AV to perform a limited or minimal risk condition (MRC) maneuver. The sensors for general operation of the autonomous vehicle may include cameras, a temperature sensor, an inertial sensor (IMU), a global positioning system, a light sensor, a LIDAR system, a radar system, and wireless communications.

A sound detection array, such as a microphone or array of microphones, may be included in the vehicle sensor subsystem 144. The microphones of the sound detection array are configured to receive audio indications of the presence of, or instructions from, authorities, including sirens and command such as “Pull over.” These microphones are mounted, or located, on the external portion of the vehicle, specifically on the outside of the tractor portion of an autonomous truck 105. Microphones used may be any suitable type, mounted such that they are effective both when the autonomous truck 105 is at rest, as well as when it is moving at normal driving speeds.

Cameras included in the vehicle sensor subsystems 144 may be rear-facing so that flashing lights from emergency vehicles may be observed from all around the autonomous truck 105. These cameras may include video cameras, cameras with filters for specific wavelengths, as well as any other cameras suitable to detect emergency vehicle lights based on color, flashing, of both color and flashing.

The vehicle control subsystem 146 may be configured to control operation of the autonomous vehicle, or truck, 105 and its components. Accordingly, the vehicle control subsystem 146 may include various elements such as an engine power output subsystem, a brake unit, a navigation unit, a steering system, and an autonomous control unit. The engine power output may control the operation of the engine, including the torque produced or horsepower provided, as well as provide control the gear selection of the transmission. The brake unit can include any combination of mechanisms configured to decelerate the autonomous vehicle 105. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from the GPS device and one or more predetermined maps so as to determine the driving path for the autonomous vehicle 105. The steering system may represent any combination of mechanisms that may be operable to adjust the heading of autonomous vehicle 105 in an autonomous mode or in a driver-controlled mode.

The autonomous control unit may represent a control system configured to identify, evaluate, and avoid or otherwise negotiate potential obstacles in the environment of the autonomous vehicle 105. In general, the autonomous control unit may be configured to control the autonomous vehicle 105 for operation without a driver or to provide driver assistance in controlling the autonomous vehicle 105. In some embodiments, the autonomous control unit may be configured to incorporate data from the GPS device, the RADAR, the LiDAR (i.e., LIDAR), the cameras, and/or other vehicle subsystems to determine the driving path or trajectory for the autonomous vehicle 105. The autonomous control that may activate systems that the autonomous vehicle 105 has which are not present in a conventional vehicle, including those systems which can allow the autonomous vehicle 105 to communicate with surrounding drivers or signal surrounding vehicles or drivers for safe operation of the autonomous vehicle 105.

An in-vehicle control computer 150, which may be referred to as a VCU, includes a vehicle subsystem interface 160, a driving operation module 168, one or more processors 170, a compliance module 166, a memory 175, and a network communications subsystem 178. This in-vehicle control computer 150 controls many, if not all, of the operations of the autonomous truck 105 in response to information from the various vehicle subsystems 140. The one or more processors 170 execute the operations that allow the system to determine the health of the autonomous vehicle 105, such as whether the autonomous vehicle 105 has a malfunction or has encountered a situation requiring service or a deviation from normal operation and giving instructions. Data from the vehicle sensor subsystems 144 is provided to VCU 150 so that the determination of the status of the autonomous vehicle 105 can be made. The compliance module 166 determines what action should be taken by the autonomous truck 105 to operate according to the applicable (i.e., local) regulations. Data from other vehicle sensor subsystems 144 may be provided to the compliance module 166 so that the best course of action in light of the AV's status may be appropriately determined and performed. Alternatively, or additionally, the compliance module 166 may determine the course of action in conjunction with another operational or control module, such as the driving operation module 168.

The memory 175 may contain additional instructions as well, including instructions to transmit data to, receive data from, interact with, or control one or more of the vehicle drive subsystem 142, the vehicle sensor subsystem 144, and the vehicle control subsystem 146 including the autonomous Control system. The in-vehicle control computer (VCU) 150 may control the function of the autonomous vehicle 105 based on inputs received from various vehicle subsystems (e.g., the vehicle drive subsystem 142, the vehicle sensor subsystem 144, and the vehicle control subsystem 146). Additionally, the VCU 150 may send information to the vehicle control subsystems 146 to direct the trajectory, velocity, signaling behaviors, and the like, of the autonomous vehicle 105. The autonomous control vehicle control subsystem may receive a course of action to be taken from the compliance module 166 of the VCU 150 and consequently relay instructions to other subsystems to execute the course of action.

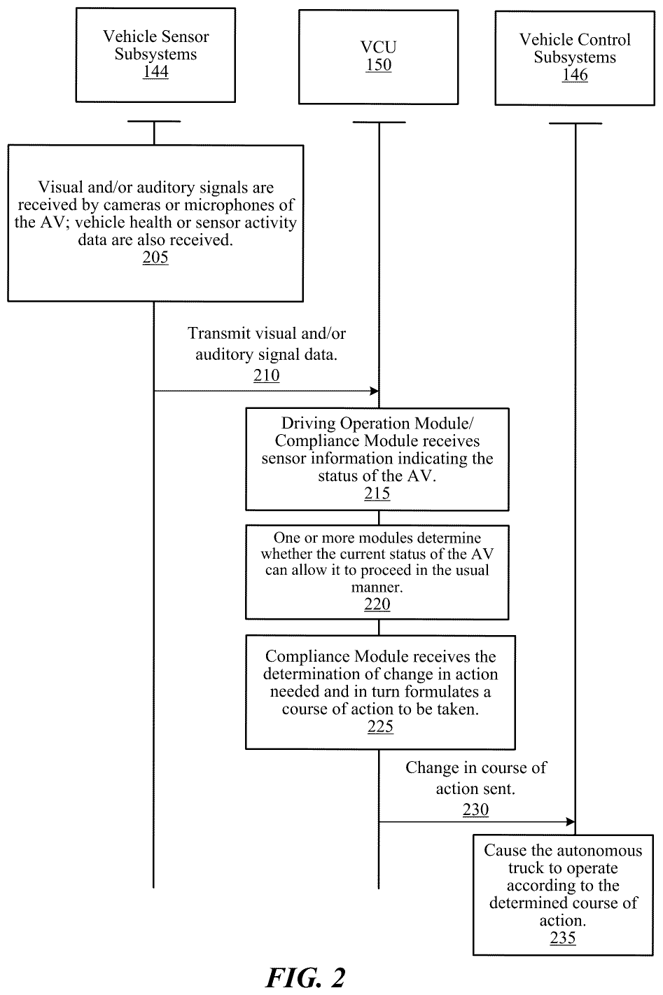

FIG. 2 shows a flow diagram for operation of an autonomous vehicle (AV) 105 safely in light of the health and surroundings of the autonomous vehicle 105. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

As shown in FIG. 2, the vehicle sensor subsystem 144 receives visual, auditory, or both visual and auditory signals indicating the at the environmental condition of the autonomous vehicle 105, as well as vehicle health or sensor activity data are received in step 205. These visual and/or auditory signal data are transmitted from the vehicle sensor subsystem 144 to the in-vehicle control computer system (VCU) 150, as in step 210. Any of the driving operation module and the compliance module receive the data transmitted from the vehicle sensor subsystem, in step 215. Then, one or both of those modules determine whether the current status of the autonomous vehicle 105 can allow it to proceed in the usual manner or that the autonomous vehicle 105 needs to alter its course to prevent damage or injury or to allow for service in step 220. The information indicating that a change to the course of the autonomous vehicle 105 is needed may include an indicator of sensor malfunction; an indicator of a malfunction in the engine, brakes, or other components necessary for the operation of the autonomous vehicle; a determination of a visual instruction from authorities such as flares, cones, or signage; a determination of authority personnel present on the roadway; a determination of a law enforcement vehicle on the roadway approaching the autonomous vehicle, including from which direction; and a determination of a law enforcement or first responder vehicle moving away from or on a separate roadway from the autonomous vehicle. This information indicating that a change to the AV's course of action is needed may be used by the compliance module to formulate a new course of action to be taken which accounts for the AV's health and surroundings, in step 225. The course of action to be taken may include slowing, stopping, moving into a shoulder, changing route, changing lane while staying on the same general route, and the like. The course of action to be taken may include initiating communications with any oversight or human interaction systems present on the autonomous vehicle. The course of action to be taken may then be transmitted from the VCU 150 to the autonomous control system, in step 230. The vehicle control subsystems 146 then cause the autonomous vehicle 105 to operate in accordance with the course of action to be taken that was received from the VCU 150 in step 235.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

### Autonomous Vehicle Oversight System

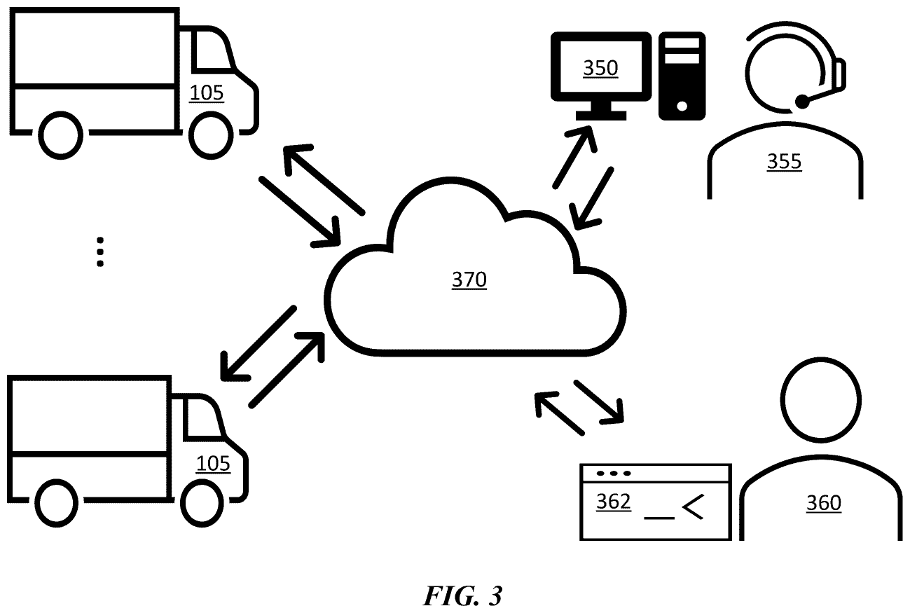

FIG. 3 illustrates a system 300 that includes one or more autonomous vehicles 105, a control center or oversight system 350 with a human operator 355, and an interface 362 for third-party 360 interaction. A human operator 355 may also be known as a remoter center operator (RCO). Communications between the autonomous vehicles 105, oversight system 350 and user interface 362 take place over a network 370. In some instances, where not all the autonomous vehicles 105 in a fleet are able to communicate with the oversight system 350, the autonomous vehicles 105 may communicate with each other over the network 370 or directly. As described with respect to FIG. 1, the VCU 150 of each autonomous vehicle 105 may include a module for network communications 178.

An autonomous vehicle 105 may be in communication with the oversight system 350. The oversight system 350 may serve many purposes, including: tracking the progress of one or more autonomous vehicles 105 (e.g., an autonomous truck); tracking the progress of a fleet of autonomous vehicles 105; sending maneuvering instructions to one or more autonomous vehicles 105; monitoring the health of the autonomous vehicle(s) 105; monitoring the status of the cargo of each autonomous vehicle 105 in contact with the oversight system 350; facilitate communications between third parties (e.g., law enforcement, clients whose cargo is being carried) and each, or a specific, autonomous vehicle 105; allow for tracking of specific autonomous vehicles 105 in communication with the oversight system 350 (e.g., third-party tracking of a subset of vehicles in a fleet); arranging maintenance service for the autonomous vehicles 105 (e.g., oil changing, fueling, maintaining the levels of other fluids); alerting an affected autonomous vehicle 105 of changes in traffic or weather that may adversely impact a route or delivery plan; pushing over the air updates to autonomous vehicles 105 to keep all components up to date; and other purposes or functions that improve the safety for the autonomous vehicle 105, its cargo, and its surroundings. An oversight system 350 may also determine performance parameters of the autonomous vehicle 105 (e.g. an autonomous truck), including any of: data logging frequency, compression rate, location, data type; communication prioritization; how frequently to service the autonomous vehicle 105 (e.g., how many miles between services); when to perform a minimal risk condition (MRC) maneuver while monitoring the vehicle's progress during the maneuver; when to hand over control of the autonomous vehicle 105 to a human driver (e.g., at a destination yard); ensuring the autonomous vehicle 105 passes pre-trip inspection; ensuring the autonomous vehicle 105 performs or conforms to legal requirements at checkpoints and weight stations; ensuring the autonomous vehicle 105 performs or conforms to instructions from a human at the site of a roadblock, cross-walk, intersection, construction, or accident; and the like.

To allow for communication between autonomous vehicles 105 in a fleet and the oversight system 350, each autonomous vehicle 105 may be equipped with a communication gateway. The communication gateway may have the ability to do any of the following: allow for AV to oversight system communication (i.e. V2C) and the oversight system to AV communication (C2V); allow for AV to AV communication within the fleet (V2V); transmit the availability or status of the communication gateway; acknowledge received communications; ensure security around remote commands between the autonomous vehicle 105 and the oversight system 350; convey the autonomous vehicle's location reliably at set time intervals; enable the oversight system 350 to ping the autonomous vehicle 105 for location and vehicle health status; allow for streaming of various sensor data directly to the oversight system 350; allow for automated alerts between the autonomous vehicle 105 and the oversight system 350; comply to ISO 21434 standards; and the like.

The oversight system 350 may be operated by one or more human, also known as an operator or a remote center operator (RCO) 355. The operator 355 may set thresholds for autonomous vehicle health parameters, so that when an autonomous vehicle 105 meets or exceeds the threshold, precautionary action may be taken. Examples of vehicle health parameters for which thresholds may be established by the operator 355 may include any of: fuel levels; oil levels; miles traveled since last maintenance; low tire-pressure detected; cleaning fluid levels; brake fluid levels; responsiveness of steering and braking subsystems; Diesel exhaust fluid (DEF) level; communication ability (e.g., lack of responsiveness); positioning sensors ability (e.g., GPS, IMU malfunction); impact detection (e.g., vehicle collision); perception sensor ability (e.g., camera, LIDAR, radar, microphone array malfunction); computing resources ability (e.g., VCU or ECU malfunction or lack of responsiveness, temperature abnormalities in computing units); angle between a tractor and trailer of the autonomous vehicle 105 in a towing situation (e.g., tractor-trailer, 18-wheeler, or semi-truck); unauthorized access by a living entity (e.g., a person or an animal) to the interior of the autonomous vehicle 105; and the like. The precautionary action may include execution of a minimal risk condition (MRC) maneuver, seeking service, or exiting a highway or other such re-routing that may be less taxing on the autonomous vehicle 105. An autonomous vehicle 105 whose system health data meets or exceeds a threshold set at the oversight system 350 or by the operator 355 may receive instructions that are automatically sent from the oversight system 350 to perform the precautionary action.

The operator 355 may be made aware of situations affecting one or more autonomous vehicles 105 in communication with or being monitored by the oversight system 350 that the affected autonomous vehicle(s) 105 may not be aware of. Such situations may include: irregular or sudden changes in traffic flow (e.g., traffic jam or accident); abrupt weather changes; abrupt changes in visibility; emergency conditions (e.g., fire, sink-hole, bridge failure); power outage affecting signal lights; unexpected road work; large or ambiguous road debris (e.g., object unidentifiable by the autonomous vehicle); law enforcement activity on the roadway (e.g., car chase or road clearing activity); and the like. These types of situations that may not be detectable by an autonomous vehicle 105 may be brought to the attention of the operator 355 through traffic reports, law enforcement communications, data from other vehicles that are in communication with the oversight system 350, reports from drivers of other vehicles in the area, and similar distributed information venues. The autonomous vehicle 105 may not be able to detect such situations because of limitations of sensor systems or lack of access to the information distribution means (e.g., no direct communication with weather agency). An operator 355 at the oversight system 350 may push such information to affected autonomous vehicles 105 that are in communication with the oversight system 350. The affected autonomous vehicles 105 may proceed to alter their route, trajectory, or speed in response to the information pushed from the oversight system 350. In some instances, the information received by the oversight system 350 may trigger a threshold condition indicating that MRC (minimal risk condition) maneuvers are warranted; alternatively, or additionally, an operator 355 may evaluate a situation and determine that an affected autonomous vehicle 105 should perform a MRC maneuver and subsequently send such instructions to the affected vehicle. In these cases, each autonomous vehicle 105 receiving either information or instructions from the oversight system 350 or the operator 355 uses its on-board computing unit (i.e. VCU) to determine how to safely proceed, including performing a MRC maneuver that includes pulling-over or stopping.

### Features of a Scene Capture System

The oversight system 350 described in connection with FIG. 3 can be used for a number of different purposes. One such purpose involves the collection of scenes or events collected from sensors 144 installed on one or more autonomous vehicles 105 that may be of interest to a user of the oversight system 350. For example, scenes or events captured using such sensors 144 can be used to train deep learning (or machine learning) techniques which may be employed in the autonomous driving of the autonomous vehicles 105.

One technique for generating training data that can be used for the training of deep learning involves the manual and time-consuming process of annotating captured scene data. Due to the importance and difficulty of generating this type of annotated scene data, there are companies dedicated solely to providing such data annotation services. When manually annotating scene data, all of the data collected from the sensors 144 of a fleet of autonomous vehicles 105 can be stored and manually annotated.

In order to provide a more efficient method for generating annotated scene data that can be used for training, aspects of this disclosure relate to systems and techniques for automatically identifying scene data collected from sensors 144 on board one or more autonomous vehicles 105 which are likely to meet defined criteria for use in training a deep learning model. This can reduce or eliminate the amount of manual processing required to provide annotated training data, leading to a much more efficient process for generating scene data that can be used for machine learning.

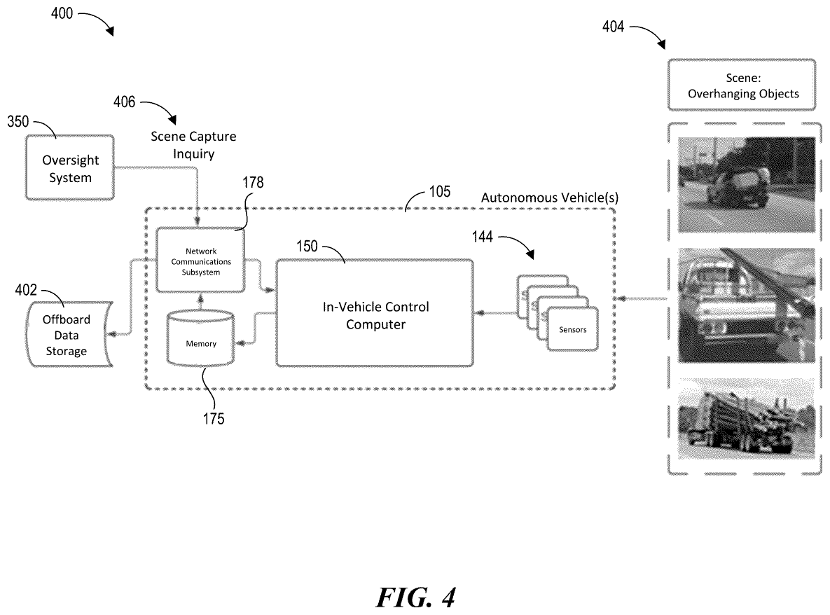

FIG. 4 illustrates another example system 400 that can be used to collect scene or event data in accordance with aspects of this disclosure. As used herein, a scene may reference to a collection of data from one or more sensors 144 of an autonomous vehicles 105 at a specific point in time (e.g., for a particular frame of data). As used herein, an event may refer to a collection of scene data over a period of time. In certain embodiments, the system 400 includes the oversight system 350, one or more autonomous vehicles 105, and an environment 404 in which the autonomous vehicle 105 can be driven. In certain embodiments, the system 400 includes an offboard data storage 402. In certain embodiments, the autonomous vehicle 105 can include a vehicle sensor subsystem 144 including one or more sensors, an in-vehicle control computer (also referred to as a processor) 150, a memory 175, and a network communications subsystem 178. Depending on the implementation, the autonomous vehicle 105 may be embodied as discussed in connection with the autonomous vehicle of FIG. 1. The offboard data storage 402 may be collocated with the oversight system 350, or may be located remotely from the oversight system 350. For example, the offboard data storage 402 may be implemented in a cloud server in certain embodiments. The offboard data storage 402 is configured to receive scene or event data from the autonomous vehicle 105, which is described in detail herein.

With reference to FIG. 3, the oversight system 350 may be configured to generate a scene capture inquiry 406 and transmit the scene capture inquiry 406 to one or more of the autonomous vehicle(s) 105. In some embodiments, the oversight system 350 may generate the scene capture inquiry 406 based on input received from the operator (also referred to as a user) 355. The user 355 may desire images or other sensor data captured by the autonomous vehicle(s) 105 in order to accomplish certain goals. The oversight system 350 may be configured to generate the scene capture inquiry 406 to include one or more parametric values that define the type(s) of sensor data to be captured and stored by the autonomous vehicle(s) 105. Depending on the implementation, the parametric values may include one or more of the following: a time of day parameter (e.g., to capture data at night, at dusk, at dawn, etc.), a geofencing parameter (e.g., to capture data within a predefined area), a road condition parameter (e.g., to capture data when certain visibility conditions are met, when surface roughness is observed, when flooding is detected or reported, when road construction is taking place, when metal plates are in use with construction, when there is uneven pavement, when there is loose gravel), a weather parameter (e.g., to capture data during fog, rain, etc.), or any other parameters of interest.

In certain implementations, the oversight system 350 may be configured to automatically generate the scene capture inquiry 406, that is, without receiving input from the user 355. For example, the oversight system 350 may receive input from one or more of the autonomous vehicle(s) 105 that indicates that a perception algorithm (also referred to as an object detection algorithm) running on the autonomous vehicle(s) 105 has a low confidence for a particular scene 404. The particular scene 404 may be defined by one or more parameters defining the environmental conditions occurring when the sensor data provided to the perception algorithm was generated. Based on this input, the oversight system 350 can generate the scene capture inquiry 406 to instruct the autonomous vehicle(s) 105 to collect additional scene data associated with the low confidence scene which can be used to train the perception algorithm.

In one example, the user 355 may desire to obtain a set of training data which can be used to train a perception algorithm (also referred to as an object detection algorithm) to identify particular scenes 404 that include overhanging objects. Accordingly, the oversight system 350 can be configured to generate the scene capture inquiry 406 with one or more parametric values that define scenes 404 that include overhanging objects. The scenes 404 illustrated in FIG. 4 of the environment illustrates a number of example images which can be captured by one or more of the sensors in the vehicle sensor subsystem 144 that correspond to the overhanging object scene. The parameter(s) of the scene capture inquiry 406 may define overhanging objects, for example, as objects which extend past a boundary of another object identified in the particular scene 404.

In certain embodiments, one or more autonomous vehicle(s) 105 are configured to receive the scene capture inquiry 406 from the oversight system 350. In order to capture the scene data more quickly, the oversight system 350 may transmit the scene capture inquiry 406 to a plurality of autonomous vehicles 105, for example, an entire fleet of autonomous vehicles 105, a plurality of autonomous vehicles 105 operating within a certain geofenced area, or any other selection of a subset of the autonomous vehicles 105 within a fleet.

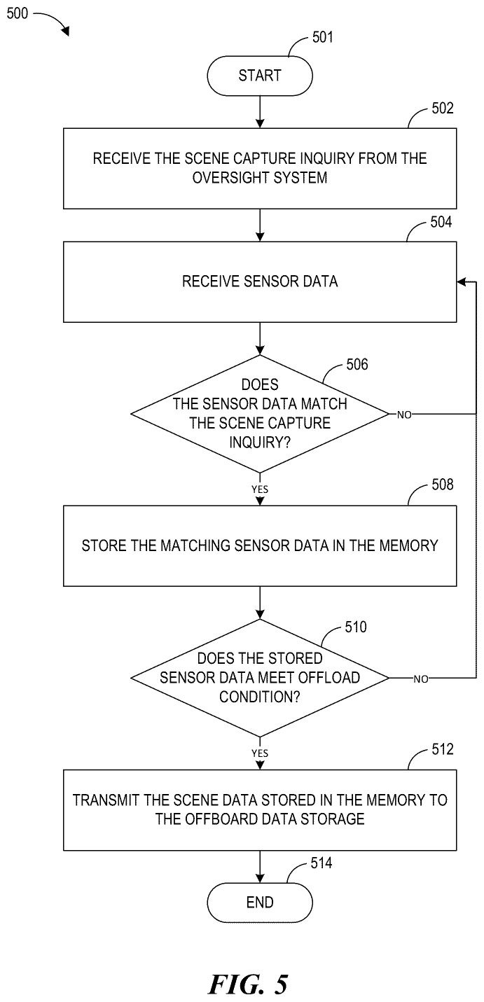

FIG. 5 illustrates an example flowchart for a method of collecting scene data used for training a deep learning model in accordance with aspects of this disclosure. With reference to FIG. 5, one or more blocks of the method 500 may be implemented, for example, by the processor 150 of the autonomous vehicle 105 shown in FIG. 4. The method 500 begins at block 501.

For ease of description, the capturing of scene data performed by a single autonomous vehicle 105 will be described herein. However, a similar process may be performed by each autonomous vehicle 105 receiving the scene capture inquiry 406 from the oversight system 350. At block 502, the autonomous vehicle 105 is configured to receive the scene capture inquiry 406 from the oversight system 350. In certain embodiments, the autonomous vehicle 105 receives the scene capture inquiry 406 via the network communications subsystem 178. As the autonomous vehicle 105 is driven through the environment, at block 504 the processor 150 receives sensor data from one or more of the sensors in the vehicle sensor subsystem 144. In certain embodiments, the sensor data originates from sensors of the vehicle sensor subsystems 144 including one or more cameras, temperature sensor(s), inertial sensor(s) (IMU), global positioning system, light sensor(s), LIDAR system, radar system, and/or a sound detection array. In certain embodiments, at least a portion of the sensor data represents one or more images of the environment. For example, the one or more images can be of a particular scene 404 such as the exemplary scenes of objects which extend past a boundary of another object in FIG. 4. In certain embodiments, the sensor data can include data that originates from multiple types of sensors from the vehicle sensor subsystems 144. Such combinations of sensor data may provide a more complete picture of the scene (e.g., camera data and temperature data). The processor 150 uses the sensor data to aid in the autonomous driving of the autonomous vehicle 105.

At block 506, the processor 150 can determine whether the sensor data (e.g., one or more images of the environment and/or combinations of sensor data) at least generally matches the parametric values from the scene capture inquiry 406. Depending on the implementation, the parametric values may include one or more of the following: a time of day parameter (e.g., to capture data at night, at dusk, at dawn, etc.), a geofencing parameter (e.g., to capture data within a predefined area), a road condition parameter (e.g., to capture data when certain visibility conditions are met), a weather parameter (e.g., to capture data during fog, rain, etc.), or any other parameters of interest. The processor 150 may be configured to determine whether the sensor data generally matches the parametric values from the scene capture inquiry 406. In certain embodiments, the sensor data is compared to the parametric values from the scene capture inquiry 406 on a frame-by-frame basis. If the sensor data does not generally match the scene capture inquiry, the process returns to block 504.

In response to the sensor data at least generally matching the parametric values from the scene capture inquiry 406, at block 508 the processor 150 is configured to store the matching sensor data in the memory 175 in the form of scene data. After, at block 510, the amount of scene data stored in the memory 175 meets an offloading condition, at block 512 the processor 150 is configured to control the network communications subsystem 178 to transmit the scene data stored in the memory 175 to the offboard data storge 402. Depending on the implementation, the offloading condition may include: a threshold amount of scene data stored in the memory 175, and/or a threshold amount of time that the processor 150 has been collecting scene data in response to the receipt of the scene capture inquiry 406. If the offloading condition is not met, the process returns to block 504. The method 500 ends at block 514.

In the overhanging object example, the processor 150 can be configured to determine whether the sensor data (e.g., one or more images of the environment and/or combinations of sensor data) includes a probable overhanging object based on the one or more parametric values included in the scene capture inquiry 406. For example, the processor 150 may be configured to identify a bounding box for other vehicle(s) in the one or more images and determine whether any object extends across the bounding box. In determining if an object extends across the bounding box, the processor 150 may determine that the one or more images likely includes an overhanging object.

The processor 150 is also configured to identify other types of scene data based on the scene capture inquiry 406 that can be used for training a deep learning model. For example, the processor 150 may be configured to identify irregularly shaped vehicles, such as oversized vehicles, houses being transported on the roadway, etc. The processor 150 may also be configured to identify different types of convoys (e.g., military convoys), accidents, and/or any other scene that may be useful for learning.

The oversight system 350 can be configured to train a deep learning model using the scene data provided to the offboard data storage 402. The trained deep learning model can then be provided to the autonomous vehicles 105 as part of the algorithms running on the processor 150 that enable the autonomous driving of the autonomous vehicles 105. By using scene data captured from the environment, the deep learning model can be more effectively trained than using training data received from other sources. In addition, using the systems and techniques described herein can provide an efficient and smart data collection used for training deep learning algorithms that can be applied to an entire fleet of autonomous vehicles 105.

In some implementations, the oversight system 350 is configured to receive an input from one or more of the autonomous vehicles 105 that indicates that the perception algorithm has a low confidence for the corresponding environmental conditions. In other implementations, the oversight system 350 is further configured to receive input from the user 355 indicative of whether the scene data stored in the offboard data storage 402 correctly matches the scene capture inquiry 406 prior to using the scene data for training the deep learning model.

As described herein, aspects of this disclosure provide systems and methods for collecting scene data from a fleet of autonomous vehicles 105 in a more cost effective, scalable and deployable way than previous efforts. Because the scene data collected from the autonomous vehicles 105 is not known to accurately reflect the scene capture inquiry 406, it is possible that some of the scene data may represent a false positive match with the scene capture inquiry 406, or there may be certain false negatives which were not captured in the scene data. However, using the scene data to train the deep learning model can improve a confidence level of the perception algorithm running on the autonomous vehicle 105 to correctly detect objects in the future.

### CONCLUSION

Though much of this document refers to an autonomous truck, it should be understood that any autonomous ground vehicle may have such features. Autonomous vehicles which traverse over the ground may include: semis, tractor-trailers, 18 wheelers, lorries, class 8 vehicles, passenger vehicles, transport vans, cargo vans, recreational vehicles, golf carts, transport carts, and the like.

While several embodiments have been provided in this disclosure, it should be understood that the disclosed systems and methods might be embodied in many other specific forms without departing from the spirit or scope of this disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

What is claimed is:

1. An autonomous vehicle, comprising:
at least one sensor configured to output sensor data;
a memory;
a network communications subsystem configured to receive a scene capture inquiry from an oversight system; and
a processor configured to:
compare the sensor data to the scene capture inquiry based at least in part on a deep learning model, and
in response to the sensor data at least generally matching the scene capture inquiry, store the sensor data in the memory as scene data,
wherein the deep learning model is trained based on the scene data.

2. The autonomous vehicle of claim 1, wherein the scene capture inquiry comprises one or more parametric values that define one or more types of the sensor data to be stored as scene data.

3. The autonomous vehicle of claim 2, wherein the one or more parametric values comprises one or more of the following: a time of day parameter, a geofencing parameter, a road condition parameter, and a weather parameter.

4. The autonomous vehicle of claim 2, wherein the processor is further configured to compare the sensor data to the one or more parametric values on a frame-by-frame basis.

5. The autonomous vehicle of claim 1, wherein the scene capture inquiry is generated by the oversight system based on an input that indicates that the deep learning model has low confidence for a scene defined by the scene capture inquiry.

6. The autonomous vehicle of claim 1, wherein the deep learning model is used as part of a perception algorithm running on the autonomous vehicle, the perception algorithm configured to detect objects within the sensor data.

7. The autonomous vehicle of claim 1, further comprising:
a vehicle drive subsystem configured to drive the autonomous vehicle based at least in part on the sensor data.

8. The autonomous vehicle of claim 1, wherein:
the processor is further configured to in response to the scene data meeting an offloading condition, transmit the scene data to an offboard data storage, and
the offloading condition comprises a threshold amount of scene data stored on the memory.

9. The autonomous vehicle of claim 1, wherein:
the processor is further configured to in response to the scene data meeting an offloading condition, transmit the scene data to an offboard data storage, and
the offloading condition comprises a threshold amount of time elapsed since the network communications subsystem received the scene capture inquiry.

10. The autonomous vehicle of claim 1, wherein the offboard data storage is a cloud server.

11. A method performed by a processor of an autonomous vehicle, comprising:
receiving sensor data output from a plurality of sensors of the autonomous vehicle;
receiving a scene capture inquiry from an oversight system via a network communications subsystem of the autonomous vehicle;
comparing the sensor data to the scene capture inquiry based at least in part on a deep learning model; and
in response to the sensor data at least generally matching the scene capture inquiry, storing the sensor data in a memory of the autonomous vehicle as scene data,
wherein the deep learning model is trained based on the scene data.

12. The method of claim 11, wherein the scene data comprises a collection of data received from two or more of the sensors substantially simultaneously.

13. The method of claim 11, further comprising:
receiving a perception algorithm comprising the trained deep learning model; and
running the perception algorithm at the autonomous vehicle.

14. The method of claim 13, further comprising:
driving the autonomous vehicle based at least in part on the sensor data and the perception algorithm.

15. The method of claim 13, wherein the perception algorithm is configured to detect objects within the sensor data.

16. A system for training a deep learning model, comprising:
an oversight system configured to generate a scene capture inquiry;
an offboard data storage; and
a plurality of autonomous vehicles, each of the autonomous vehicles comprising:
a vehicle sensor subsystem comprising a plurality of sensors configured to output sensor data,
a memory,
a network communications subsystem configured to receive the scene capture inquiry from the oversight system, and
a processor configured to:
compare the sensor data to the scene capture inquiry based at least in part on a deep learning model, and
in response to the sensor data at least generally matching the scene capture inquiry, store the sensor data in the memory as scene data,
wherein the deep learning model is trained based on the scene data.

17. The system of claim 16, wherein the oversight system is configured to receive an input from a user identifying a type of scene to be obtained by the autonomous vehicles, wherein the generation of the scene capture inquiry is based on the input received from the user.

18. The system of claim 16, wherein the processor of each of the autonomous vehicles is further configured to:
run a perception algorithm configured to identify objects in the sensor data for the corresponding autonomous vehicle; and
generate a confidence value indicative of a confidence that objects detected by the perception algorithm are accurate based on one or more parameters defining environmental conditions when the sensor data was obtained.

19. The system of claim 18, wherein the oversight system is configured to receive an input from one or more of the autonomous vehicles that indicates that the perception algorithm has a low confidence for the corresponding environmental conditions.

20. The system of claim 16, wherein the oversight system is further configured to receive input from a user indicative of whether the scene data stored in the offboard data storage correctly matches the scene capture inquiry prior to using the scene data for training the deep learning model.
